(19) United States
(12) Patent Application Publication
(10) Pub. No.: US 2026/0008171 A1
(43) Pub. Date: Jan. 8, 2026

(54) PORTABLE VARIABLE BOWLING BALL WORK STAND

(71) Applicant: Jae-gon Kim, Daegu (KR)

(72) Inventor: Jae-gon Kim, Daegu (KR)

(21) Appl. No.: 19/254,016

(22) Filed: Jun. 30, 2025

(30) Foreign Application Priority Data
Jul. 5, 2024 (KR) 10-2024-0088813

(51) Int. Cl. B25H 1/00; A63D 5/00

(52) U.S. Cl. CPC B25H 1/0042; A63D 5/00

(57) ABSTRACT

The present invention relates to a support device placed between a floor and a bowling ball to safely protect and store the ball. It comprises a first and second support plate, each with frames and accommodating protrusions to cradle the bowling ball, and a coupling means that axially connects the plates. Through axial rotation, the support plates can unfold or fold, enabling compact storage, easy portability, and minimizing surface contact to prevent scratches. The design allows the ball to rotate with minimal force for cleaning or drilling preparation. This structure not only reduces manufacturing costs by using a simple dual-plate system but also enhances usability by providing a multifunctional stand that supports, protects, and facilitates cleaning and transportation of the bowling ball.

### CROSS-REFERENCE TO RELATED APPLICATION

This application claims priority to and the benefit of Korean Patent Application No. 10-2024-0088813, filed on Jul. 5, 2024, the disclosure of which is incorporated herein by reference in its entirety.

### BACKGROUND

### Technical Field

The present invention relates to a portable variable bowling ball work stand. More specifically, the present invention relates to the portable variable bowling ball work stand that may reduce manufacturing costs by using a pair of support plates as a stand for a bowling ball by rotating them while being axially coupled by a coupling means, thereby having an advantage in price competitiveness, safely stores and protects the bowling ball while minimizing contact between the surface of the bowling ball and a ball caster provided on the top while the support plate is axially rotated and unfolded, thereby resolving the problem of scratching or damaging the outer surface, rotates the bowling ball that is engaged on the top with the rotation of the ball caster with little force, making it easy to wipe off foreign substances or clean, and also making it easy to perform basic work for the drilling work of the bowling ball, and may minimize the usable space according to the rotation range by rotating a pair of unfolded support plates in the opposite direction and folding them to a certain size, so that the storage, protection, exterior cleaning, and portability of the bowling ball may all be performed with only the combined support even before and after use or when the place of use changes.

### Background Art

Conventionally, bowling is one of the popular sports domestically and abroad, and this game is ideal to enjoy with family, friends, or co-workers, and adds enjoyment and engagement as skills improve. However, one of the important pieces of equipment that should not be left out when bowling is the bowling ball support. Such a bowling ball support is one of the items required for bowling and is designed to store the bowling ball safely and efficiently. The material mainly used is plastic, and there is a hole for storing the ball, which prevents the ball from rolling, so that the bowling ball may be easily taken care of and keep the space tidy, so it is necessary to pair it with the bowling ball.

As an example, Korean Patent Laid-Open Publication No. 10-2021-0158200 discloses a “rotary bowling ball support including a Y-shaped support plate and a nylon ball caster”. This prior art document provides the effect that it is easy to rotate the ball and that the chances of scratching the ball are reduced.

However, according to the prior art, although the ball caster made of nylon is attached to each end of the Y-shaped support plate, even if the bowling ball is placed on the ball caster, as shown in the drawing, the joint between the lower part of the ball caster and the Y-shaped support plate is weak enough to sufficiently support the load of the bowling ball, so there is a risk of it spreading outward or breaking and even if the bowling ball is moved to rotate while in contact with the ball caster, it does not rotate smoothly due to the problem of the shape of the support plate spreading outward. In addition, since the shape of the support plate should be maintained during movement, it is necessary to resolve the inconvenience of portability and movement.

### SUMMARY

### Technical Problem

An object of the present invention to fundamentally improve the above-mentioned problems is to simplify the structure and reduce the manufacturing cost by using the pair of backing plates as the backing tool of the bowling ball by rotating in a state of being axially coupled by the coupling means, and to solve the problem that the outer surface is scratched or damaged by safely storing and protecting the bowling ball while minimally abutting the surface of the ball caster and the bowling ball provided on the upper portion in a state in which the backing plate is axially rotated and unfolded, and to provide an effect that the bowling ball engaged with the upper portion is easily wiped or cleaned by rotating the ball caster with a small force, as well as basic work for drilling the bowling ball is easily performed, the space for use according to the rotation category can be reduced as much as possible by rotating the pair of unfolded backing plates in reverse and folding them to a certain size, and the storage, protection, cleaning of the outer surface, and portability of the bowling ball can be all performed only by the backing tool coupled before and after use or change of the place of use.

### Technical Solution

In order to achieve the above-mentioned object, the present invention provides a support, which floats between a floor and a bowling ball to safely protect the bowling ball, including: a first support plate including a first frame having a length and a thickness in a longitudinal direction so as to be positioned between the floor and the bowling ball, and including first accommodating protrusion portions in which an accommodating surface is formed above the first frame so as to accommodate the bowling ball; a second support plate including a second frame having a length and a thickness in the longitudinal direction so as to be formed in a pair while overlapping the first support plate in the vertical direction, and including second accommodating protrusion portions in which an accommodating surface is formed above the second frame to accommodate the bowling ball; and a coupling means which is provided to axially couple to the center of the first support plate and the second support plate, and which variably protects the bowling ball according to the axial rotation of the first support plate and the second support plate or facilitates the simultaneous portability.

In this case, the first accommodating protrusion portions of the first support plate according to the present invention are formed to protrude to face each other at a certain distance from the center of the first frame, includes an accommodating surface that curves downward from the outside toward the center of the first frame based on the upper portions of the first accommodating protrusion portions, and includes a side end surface that narrows from the outside toward the center of the first frame based on one side surface of the first accommodating protrusion portions.

In this case, the second accommodating protrusion portions of the second support plate according to the present invention are formed to protrude to face each other at a certain distance from the center of the second frame, includes an accommodating surface that curves downward from the outside toward the center of the second frame based on the upper portions of the second accommodating protrusion portions, and includes a side end surface that narrows from the outside toward the center of the second frame based on one side of the second accommodating protrusion portions.

In this case, the first support plate and the second support plate according to the present invention are respectively provided with rotating ball casters on the accommodating surfaces of the first accommodating protrusion portions and the second accommodating protrusion portions, so as to minimally contact the outer surface of the bowling ball and protect the outer surface, and the outer surface of each bowling ball is easily cleaned by the rotation of the ball casters.

At this time, the coupling means according to the present invention is configured to accommodate and protect the bowling ball when the first frame and the second frame are unfolded by selecting any one of a concavo-convex type, a ball-plunger type, and a screw type at the center of the first frames according to the rotation of the axis, and to easily perform portability for movement when folded.

Prior to this, the terms and words used in the specification and claims should not be construed as being limited to their ordinary or dictionary meanings but should be interpreted as meanings and concepts consistent with the technical spirit of the present invention based on the principle that the inventors may appropriately define the concepts of the terms in order to best explain their own inventions. Therefore, it should be understood that the embodiments described in this specification and the configurations shown in the drawings are merely one of the most preferred embodiments of the present invention, and do not represent all the technical ideas of the present invention. Therefore, at the time of filing this application, there may be various equivalents and modifications that may replace them.

### BRIEF DESCRIPTION OF THE DRAWINGS

FIG. 1 is an engagement perspective view showing an engagement state of a work support according to the present invention.

FIG. 2 is an exploded perspective view showing an exploded state of the work support according to the present invention.

FIG. 3 is a use state diagram showing a folded state of the work support according to the present invention.

FIG. 4 is an operation state diagram showing the operation state of the work support according to the present invention.

FIG. 5 is a cross-sectional view showing a use state of the work support according to the present invention in a working state.

FIGS. 6 and 7 are exemplary diagrams showing an embodiment of a coupling means according to the invention.

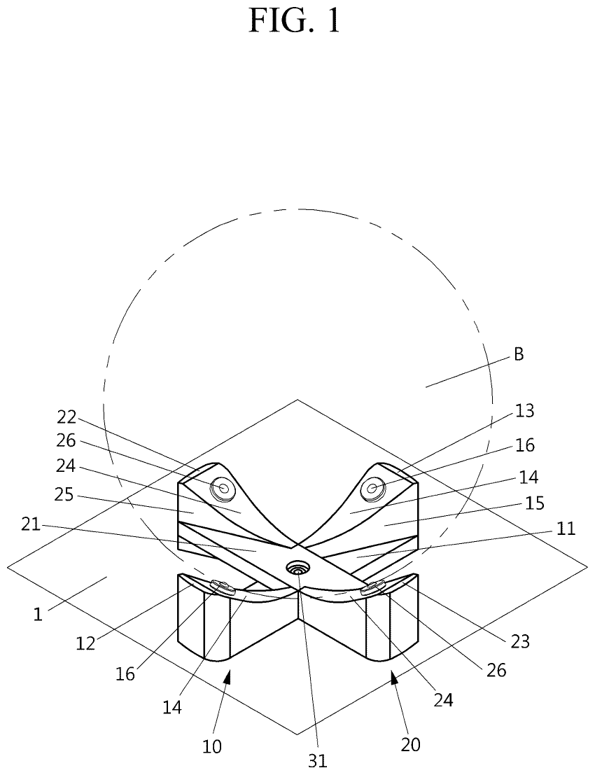

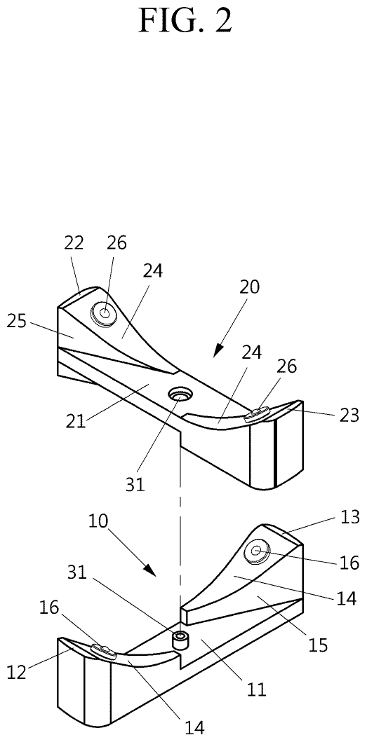

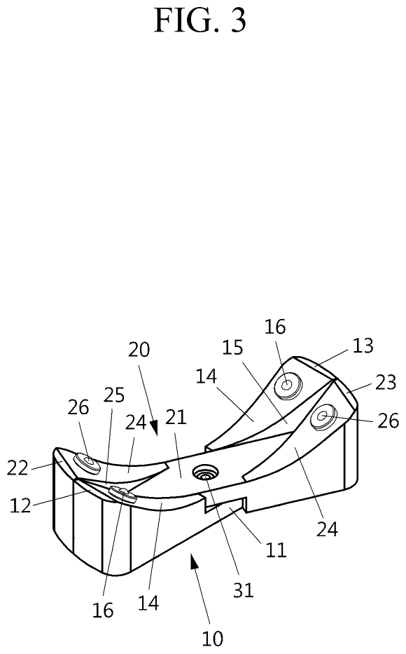

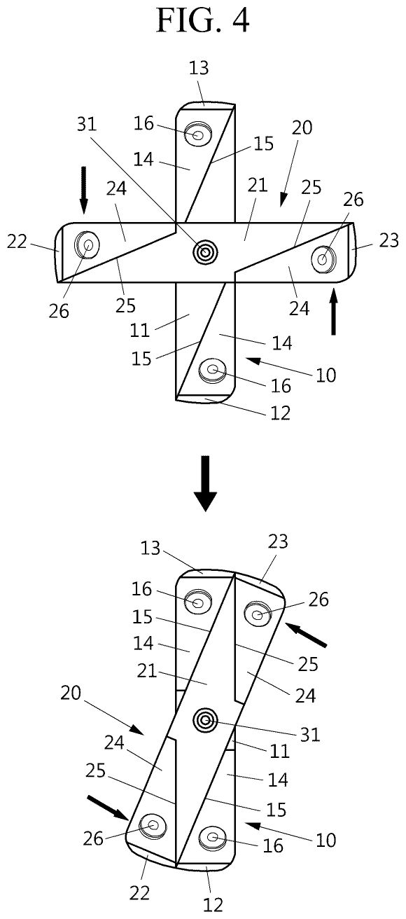

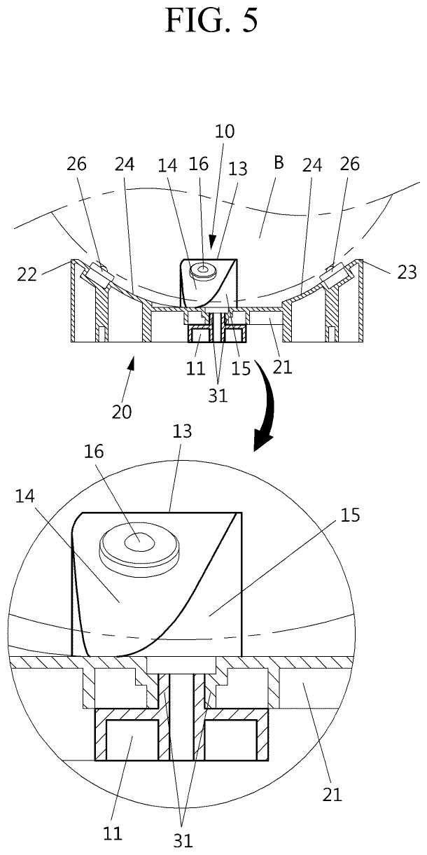

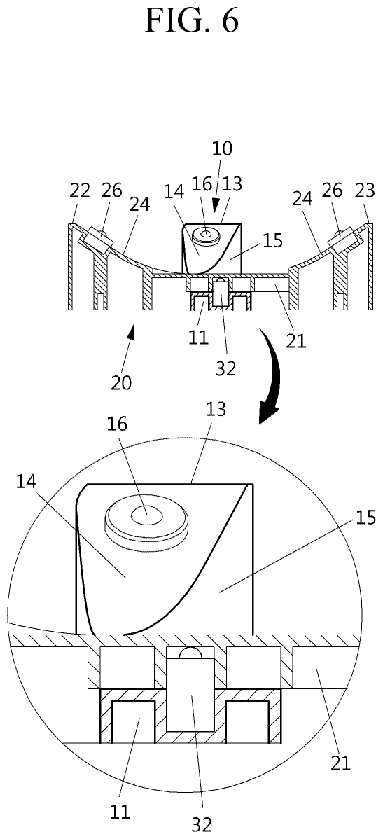

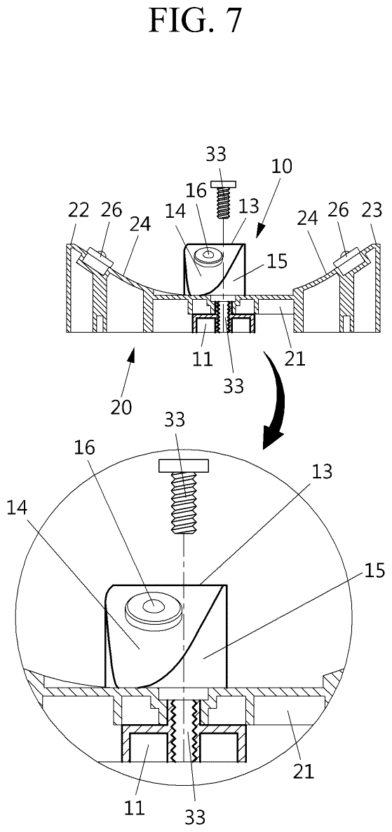

### DETAILED DESCRIPTION

Hereinafter, preferred embodiments of the present invention will be described in detail with reference to the accompanying drawings.

The present invention relates to a support that floats between floor 1 and a bowling ball B to safely protect the bowling ball B, and mainly includes a first support plate 10, a second support plate 20, and a coupling means.

According to the invention, the first support plate 10 including a first frame 11 having a longitudinal length and thickness so as to be positioned between floor 1 and the bowling ball B includes the first accommodating protrusion portions 12 and 13 in which an accommodating surface 14 is formed above the first frame 11 so as to accommodate the bowling ball B. The first support plate 10 is used as a protective plate that separates the surface of bowling ball B from floor 1 by leaving a space between the surface and floor 1 so that the surface of bowling ball B may be damaged by friction or impact with the floor 1 when the bowling ball B comes into direct contact with floor 1, which may affect its function as a ball or its service life. The main structure of the first support plate 10 includes a first frame 11 and the first accommodating protrusion portions 12 and 13. The first frame 11 is formed to have a length and a thickness in a longitudinal direction so as to be positioned between floor 1 and the bowling ball B, and the first accommodating protrusion portions 12 and 13 are integrally provided on the top of the first frame 11 and form an accommodating surface 14 capable of accommodating the ball B on the top of first frame 11.

In this case, according to a detailed configuration of the present disclosure, the first accommodating protrusion portions 12 and 13 are formed to protrude to face each other at a certain distance from the center of the first frame 11, includes an accommodating surface 14 that curves downward from the outside toward the center of the first frame 11 based on the upper portions of the first accommodating protrusion portions 12 and 13, and includes a side end surface 15 that narrows from the outside toward the center of the first frame 11 based on one side surface of the first accommodating protrusion portions 12 and 13. Specifically, the configuration of the first support plate 10 is described as follows: the first accommodating protrusion portions 12 and 13 are formed to protrude outwardly of the first frame 11 at a certain distance with respect to the central portion of the first frame, and the accommodating surface 14 forms a curved surface from the outer direction to the inner direction, which is the center of the first frame 11, with respect to the upper surfaces of the first accommodating protrusion portions 12 and 13 that protrudes opposite to the upper end of the first frame, and is not formed horizontally along the same line, but is formed to have a downward curve from the outer direction of the first accommodating protrusion portions 12 and 13 toward the center of the first frame 11 with the same or similar curvature of the outer surface of the bowling ball B so that it may accommodate the ball. In summary, the first accommodating protrusion portions 12 and 13 are extended to protrude from the upper portion of the first frame 11 so as to face the edge in the outward direction, and the accommodating surface 14 is provided with a downward curve that is evenly inclined inwardly from the outer direction of the first accommodating protrusion portions 12 and 13 to the center of the first frame 11.

The first accommodating protrusion portions 12 and 13 have a side end surface 15, which connects the upper surface of the first frame 11 and the accommodating surfaces 14 of the first accommodating protrusion portions 12 and 13, and is formed as a diagonal cross-section that becomes narrower from the outer direction of the side toward the inner direction corresponding to the center of the first frame 11 based on one side of the first accommodating protrusion portions 12 and 13, and overall, the side end surface 15 of the first accommodating protrusion portions 12 and 13 is formed as a diagonal cross-section, and the upper end of the first frame 11 that comes into contact with the side end surface 15 is formed as a rhombus shape excluding the first accommodating protrusion portions 12 and 13.

According to the present invention, the second support plate 20 includes a second frame 21 having a length and a thickness in the longitudinal direction so as to be formed in a pair while overlapping the first support plate 10 in the vertical direction, and a second accommodating protrusion portions 22 and 23 in which an accommodating surface 24 is formed above the second frame 21 to accommodate the bowling ball B. The second support plate 20 is formed as a pair by overlapping the first support plate 10 vertically and is used as a protective plate to separate the bowling ball B by spacing it out from floor 1, and is provided with a second frame 21 having a length and a thickness in the longitudinal direction like the first support plate 20, and is integrally provided with second accommodating protrusion portions 22 and 23 at the upper portion of the second frame 21, and forms an accommodating surface 24 on the upper end of the second accommodating protrusion portions 22 and 23 so that the bowling ball B may be accommodated on the upper portion of the second frame 21.

In addition, the second support plate 20 has the same configuration as the first support plate 10, but the second support plate 20 is used as a pair while being overlapped and in contact with the upper surface of the first support plate 10, so there is a difference in the configuration height of the first frame 11 and the second frame 21 when applying the basic structure of overlapping by stacking them vertically with the second frame 21 placed on top of the first frame 11, and the first accommodating protrusion portions 12 and 13 and the second accommodating protrusion portions 22 and 23, which are formed to protrude oppositely from the upper portions of the first frame 11 and the second frame 21, are formed with downward-curved surfaces 14 and 24 on the upper sides of the first accommodating portions 12 and 13 and the second accommodating portions 22 and 23 in the same curvature in the process of separating the floor 1 and the bowling ball B by forming the upper and lower heights to be the same and leaving a space between them, and is connected to the coupling means described later, so the outer surface of the lower end of the bowling ball B may be easily accommodated and stored on the accommodating surfaces 14 and 24 in proportion to the height of the downward curved surface.

In other words, the first accommodating protrusion portions 12 and 13 and the second accommodating protrusion portions 22 and 23 are configured to have the same height and have the accommodating surfaces 14 and 24 curved downward in the center at the upper portion, and the first frame 11 needs to be provided to overlap and engage with the second frame 21 in the vertical direction, so that the first frame 11 is formed at the lower portion directly in contact with the floor 1, and the second frame 21 is formed to have the same length and thickness at a position increased by the thickness of the first frame 11 and is coupled with the configuration of the coupling means described later, thereby facilitating the storage of the bowling ball B.

At this time, according to the detailed configuration of the present disclosure, the second accommodating protrusion portions 22 and 23 of the second support plate 20 are formed to protrude to face each other at a certain distance from the center of the second frame 21, includes an accommodating surface 24 that curves downward from the outside toward the center of the second frame 21 based on the upper portions of the second accommodating protrusion portions 22 and 23, and includes a side end surface 25 that narrows from the outside toward the center of the second frame 21 based on one side of the second accommodating protrusion portions 22 and 23. The second accommodating protrusion portions 22 and 23 are formed to protrude from a center point of the second frame 21 at a certain distance in an outward direction and have a downwardly curved accommodating surface 24 that forms a curvature by decreasing in height from the outer direction of the second frame 21 toward the inner direction corresponding to the center based on the upper end portions of the second accommodating protrusion portions 22 and 23, thereby serving as an accommodating groove that safely accommodates the bowling ball B on the upper accommodating surfaces 24 of the second accommodating protrusion portions 22 and 23 formed by protruding while facing each other.

In addition, side end surfaces 25 that cross both side surfaces of the second accommodating protrusion portions 22 and 23 in the diagonal direction at the upper end portion of the second frame 21 are provided on the side of the second accommodating protrusion portions 22 and 23, and are formed to face the side end surfaces 15 of the first accommodating protrusion portions 12 and 13 while facing each other.

The reason why the side end surfaces 15 and 25 are provided on the first accommodating protrusion portions 12 and 13 and the second accommodating protrusion portions 22 and 23 is that, in the process of performing an axial rotation to unfold and fold the first support plate 10 and the second support plate 20 at a certain angle by applying a coupling means described later based on the center portions of the first frame 11 and the second frame 21 while engaging with the first frame 11 and the second frame 21 in a vertically overlapping manner, the side surface of the first accommodating protrusion portions 12 and 13 and the side surface of the second accommodating protrusion portions 22 and 23 may be folded so that they face each other against the side surface of the first frame 11 and the side surface of the second frame 21 and thus, the purpose is to accommodate a bowling ball B on the accommodating surfaces 14 and 24 and protect the surface while the first support plate 10 and the second support plate 20 are unfolded, and to use them as a folding space to reduce the volume of the first support plate 10 and the second support plate 20 when it is finished being used or not being used, or when it is carried and transported and moved directly depending on the place of use.

In other words, in the case where the side end surfaces 15 and 25 are not provided, the first frame 11 and the second frame 21 are overlapped vertically, and there is no folding space due to the axial rotation through the coupling means in the central portion, so the rotation itself may not be achieved. Therefore, the first support plate 10 and the second support plate 20 are implemented only in a state of being extended at right angles in the front-rear and left-right directions while being overlapped up and downward in the central portion to accommodate the bowling ball B or are used in the unfolded state even after accommodating is complete. In particular, since it has the disadvantage of being inconvenient to carry during the transport process, in order to secure a folding space that may be folded and unfolded to minimize the volume, the side surfaces of the first accommodating protrusion portions 12 and 13 and the second accommodating protrusion portions 22 and 23 are configured with inclined side end surfaces 15 and 25. Therefore, the usable range of the first support plate 10 and the second support plate 20 may be adjusted before and after use.

In addition, according to the detailed configuration of the present disclosure, the first support plate 10 and the second support plate 20 are respectively provided with rotating ball casters 16 and 26 on the accommodating surfaces 14 and 24 of the first accommodating protrusion portions 12 and 13 and the second accommodating protrusion portions 22 and 23, so as to minimally contact the outer surface of the bowling ball B and protect the outer surface, and the outer surface of each bowling ball B is easily cleaned by the rotation of the ball casters 16 and 26. The first support plate 10 and the second support plate 20 are provided with accommodating surfaces 14 and 24 which respectively protrude from the first accommodating protrusion portions 12 and 13 and the second accommodating protrusion portions 22 and 23 so as to face each other and which are formed to be downwardly curved toward the center at the upper portions of the first accommodating protrusion portions 12 and 13 and the second accommodating protrusion portions 22 and 23, and the accommodating surfaces 14 and 24 is provided with ball casters 16 and 26 including a rotary ball while being inserted, respectively, so that the outer surface of the bowling ball B is accommodated in the accommodating surface 14 and 24 and directly engages with the ball casters 16 and 26 while minimally abutting to protect the outer surface from being damaged or broken, and according to the rotation of the ball casters 16 and 26, the bowling ball B abutting to the outer surface is turned or rotated in a certain direction, and the outer surface cleaning for wiping off or removing foreign substances adhering to the outer surface may be easily performed, as well as the basic work for drilling the bowling ball may be easily performed.

In addition, the role of safely protecting the outer surface of the bowling ball B from the external environment while accommodating the bowling ball B on the accommodating surfaces 14 and 24 and making direct contact with it may be performed in the same manner during the process of using the ball casters 16 and 26. However, when the outer surface is cleaned while the ball B is turned or rotated in a state where it is in contact with the accommodating surfaces 14 and 24, due to the weight of the ball B, the ball B may not be easily rotated due to surface friction in a state where an external surface of the ball B is in close contact with the accommodating faces 14 and 24. Therefore, in the present invention, as a method of minimizing the influence of weight and friction, the ball casters 16 and 26 including the rotating balls are inserted and provided on the accommodating surfaces 14 and 24, so that when the bowling ball B is rotated while the outer surface of the ball casters 16 and 26 are minimally in contact with the outer surface of the bowling ball B, the rotating balls of the ball casters 16 and 26 are also engaged and rotates together, so that external cleaning of the bowling ball B may be easily performed with little force.

According to the present invention, the coupling means provided to be axially coupled at the center of the first support plate 10, and the second support plate 20 protects the bowling ball B or facilitates portability when moving it by being variable according to the axial rotation of the first support plate 10 and the second support plate 20. The coupling means is configured to be axially coupled to rotate while connecting the first support plate 10 and the second support plate 20 and overlapping them vertically based on the midpoint of the first support plate 10 and the second support plate 20. By rotating in one direction based on the coupled axis while the first support plate 10 and the second support plate 20 are vertically axially coupled based on the midpoint, the bowling ball B is brought into contact with the ball casters 16 and 26 of the accommodating surfaces 14 and 24 in a state where the first support plate 10 and the second support plate 20 are unfolded, thereby safely protecting the outer surface of the bowling ball B. By rotating the first support plate 10 and the second support plate 20 in different directions based on the coupled axis, the side end surfaces 15 and 25 provided on the first accommodating protrusion portions 12 and 13 and the second accommodating protrusion portions 22 and 23 are folded so as to be in close contact with the side surface portions of the second frame 21 and the first frame 11, respectively, thereby applying variability. So, even when the place or position of storing the bowling ball B is changed or moved, portability may be easily achieved when the first support plate 10 and the second support plate 20 are folded and moved. Therefore, it has the effect of solving two roles of storage, protection, and movement of a bowling ball B with a single support.

At this time, according to the detailed configuration of the present disclosure, the coupling means is configured to accommodate and protect the bowling ball B when the first frame 11 and the second frame 21 are unfolded by selecting any one of a concavo-convex type 31, a ball-plunger type 32, and a screw type 33 at the center of the first frames 11 and 12 according to the rotation of the axis, and to easily perform portability for movement when folded. Types of the coupling mean include the concavo-convex method 31, the ball-plunger method 32, and the screw method 33. The concavo-convex method 31 is to rotate the first frame 11 and the second frame 21 around the axis in a state in which a convex portion and a concave portion are formed in the upper and lower portions of the central portions of the first frame 11 and the second frame 21 and these components are inserted and joined in a male and female manner, and that the outer surface of the bowling ball B is accommodated by the first accommodating protrusion portions 12 and 13 and the second accommodating protrusion portions 22 and 23 while the first support plate 10 and the second support plate 20 are spread apart, and the ball casters 16 and 26 that rotates on the upper accommodating surfaces 14 and 24 of the first accommodating protrusion portions 12 and 13 and the second accommodating protrusion portions 22 and 23 comes into contact with the outer surface of the bowling ball B while minimally engaging it, thereby safely protecting the bowling ball B. By applying the concavo-convex type 31 in which the convex portion and the concave portion are axially coupled, the first frame 11 and the second frame 21 are unfolded during use, and after use or during movement, the use space according to the rotational ranges of the first support plate 10 and the second support plate 20 is reduced as much as possible in a state in which the first frame 11 and the second frame 21 are axially rotated and are folded at a certain angle, thereby facilitating portability due to movement.

In addition, the ball-plunger type 32 is similar to the concavo-convex type 31 described above in the coupling method of the first frame 11 and the second frame 21, but a ball-plunger is provided instead of the convex portion of the concave-convex method 31, and a type of inserting and axially coupling to the concave portions formed in the upper and lower portions of the first and second frames 11 and 21 is applied. The ball-plunger is configured with an elastic force that pushes upward by installing a spring and a tension ball inside the body and is mainly used when holding a position, applying pressure, or lifting.

The first frame 11 and the second frame 21 are provided with the ball-plunger and concave portion on the upper and lower surfaces respectively, and these configurations are combined in a male-female manner so that the centers of the first frame 11 and the second frame 21 are axially coupled and rotated like the concave-convex method 31, so that when the first frame 11 and the second frame 21 are unfolded, the ball casters 16 and 26 that rotates on the upper accommodating surfaces 14 and 24 of the first accommodating protrusion portions 12 and 13 and the second accommodating protrusion portions 22 and 23 minimally engages with the outer surface of the bowling ball B, thereby safely protecting the bowling ball B, and when the first frame 11 and the second frame 21 are folded, the portability is facilitated during movement and the usable range is minimized, thereby playing the role of the concave-convex method 31.

In addition, screw type 33 is provided in the central portions of the first frame 11 and the second frame 21 to play the role of holding the center position, as in the concavo-convex type 31 and the ball-plunger type 32. A screw groove is formed in the center of the first frame 11 and the second frame 12 so as to open up and down or only partially open, and a screw is inserted into the screw groove. When the first frame 11 is axially connected to the second frame 21 integrally, and the first frame 11 and the second frame 21 are unfolded by rotating the axis according to change, the ball casters 16 and 26 rotating on the upper accommodating surfaces 14 and 24 of the first accommodating protrusion portions 12 and 13 and the second accommodating protrusion portions 22 and 23 comes into contact with the outer surface of the bowling ball B while minimally engaging with the outer surface, thereby safely protecting the bowling ball B, and easily performing portability when the first frame 11 moves in a folded state as in the concave-convex method 31 and the ball-plunger type 32.

In this way, the present invention provides the effects of reducing manufacturing costs by using a pair of support plates as a stand for a bowling ball by rotating them while being axially coupled by a coupling means, thereby having an advantage in price competitiveness, safely storing and protecting the bowling ball while minimizing contact between the surface of the bowling ball and a ball caster provided on the top while the support plate is axially rotated and unfolded, thereby resolving the problem of scratching or damaging the outer surface, rotating the bowling ball that is engaged on the top with the rotation of the ball caster with little force, making it easy to wipe off foreign substances or clean, and also making it easy to perform basic work for the drilling work of the bowling ball, and minimizing the usable space according to the rotation range by rotating a pair of unfolded support plates in the opposite direction and folding them to a certain size, so that the storage, protection, exterior cleaning, and portability of the bowling ball may all be performed with only the combined support even before and after use or when the place of use changes.

According to the present invention as described in the above structure and operation, provided are the effects of reducing manufacturing costs by using a pair of support plates as a stand for a bowling ball by rotating them while being axially coupled by a coupling means, thereby having an advantage in price competitiveness, safely storing and protecting the bowling ball while minimizing contact between the surface of the bowling ball and a ball caster provided on the top while the support plate is axially rotated and unfolded, thereby resolving the problem of scratching or damaging the outer surface, rotating the bowling ball that is engaged on the top with the rotation of the ball caster with little force, making it easy to wipe off foreign substances or clean, and also making it easy to perform basic work for the drilling work of the bowling ball, and minimizing the usable space according to the rotation range by rotating a pair of unfolded support plates in the opposite direction and folding them to a certain size, so that the storage, protection, exterior cleaning, and portability of the bowling ball may all be performed with only the combined support even before and after use or when the place of use changes.

The present invention is not limited to the described embodiments, and it is apparent to those skilled in the art that various modifications and variations may be made without departing from the spirit and scope of the present invention. Therefore, such variations or modifications are intended to fall within the scope of the claims of the present invention.

Description of Reference Numerals

| | | | |
|---|---|---|---|
| 1 | Floor | 10 | First support plate |
| 11 | First frame | 12, 13 | First accommodating |
| | | | protrusion portion |
| 14 | accommodating surface | 15 | Side end surface |
| 16 | Ball caster | 20 | Second support plate |
| 21 | Second frame | 22, 23 | Second accommodating |
| | | | protrusion portion |
| 24 | Accommodating surface | 25 | Side end surface |
| 26 | Ball caster | 31 | Concavo-convex type |
| 32 | Ball-plunger type | 33: | Screw type |
| B: | Bowling ball | | |

What is claimed is:

1. A portable variable bowling ball work stand, which floats between floor 1 and a bowling ball B to safely protect the bowling ball B, comprising:
a first support plate 10 comprising a first frame 11 having a length and a thickness in a longitudinal direction so as to be positioned between the floor 1 and the bowling ball B, and comprising first accommodating protrusion portions 12 and 13 in which an accommodating surface 14 is formed above the first frame 11 so as to accommodate the bowling ball B;
a second support plate 20 comprising a second frame 21 having a length and a thickness in the longitudinal direction so as to be formed in a pair while overlapping the first support plate 10 in the vertical direction, and comprising second accommodating protrusion portions 22 and 23 in which an accommodating surface 24 is formed above the second frame 21 to accommodate the bowling ball B; and
a coupling means which is provided to axially couple to the center of the first support plate 10 and the second support plate 20, and which variably protects the bowling ball B according to the axial rotation of the first support plate 10 and the second support plate 20 or facilitates the simultaneous portability.

2. The portable variable bowling ball work stand of claim 1,
wherein the first accommodating protrusion portions 12 and 13 of the first support plate 10 are formed to protrude to face each other at a certain distance from the center of the first frame 11, comprises an accommodating surface 14 that curves downward from the outside toward the center of the first frame 11 based on the upper portions of the first accommodating protrusion portions 12 and 13, and comprises a side end surface 15 that narrows from the outside toward the center of the first frame 11 based on one side surface of the first accommodating protrusion portions 12 and 13.

3. The portable variable bowling ball work stand of claim 1,
wherein the second accommodating protrusion portions 22 and 23 of the second support plate 20 are formed to protrude to face each other at a certain distance from the center of the second frame 21, comprises an accommodating surface 24 that curves downward from the outside toward the center of the second frame 21 based on the upper portions of the second accommodating protrusion portions 22 and 23, and comprises a side end surface 25 that narrows from the outside toward the center of the second frame 21 based on one side of the second accommodating protrusion portions 22 and 23.

4. The portable variable bowling ball work stand of claim 1,
wherein the first support plate 10 and the second support plate 20 are respectively provided with rotating ball casters 16 and 26 on the accommodating surfaces 14 and 24 of the first accommodating protrusion portions 12 and 13 and the second accommodating protrusion portions 22 and 23, so as to minimally contact the outer surface of the bowling ball B and protect the outer surface, and the outer surface of each bowling ball B is easily cleaned by the rotation of the ball casters 16 and 26.

5. The portable variable bowling ball work stand of claim 1,
wherein the coupling means is configured to accommodate and protect the bowling ball B when the first frame 11 and the second frame 21 are unfolded by selecting any one of a concavo-convex type 31, a ball-plunger type 32, and a screw type 33 at the center of the first frames 11 and 12 according to the rotation of an axis, and to easily perform portability for movement when folded.
